(19) United States
(12) Patent Application Publication
(10) Pub. No.: US 2014/0120500 A1
(43) Pub. Date: May 1, 2014

(54) INTEGRATED FLIGHT TRAINING AND EVALUATION SYSTEMS AND METHODS FOR HANDHELD AND PORTABLE NAVIGATION DEVICES

(71) Applicant: HONEYWELL INTERNATIONAL INC., Morristown, NJ (US)

(72) Inventors: Jonathan Matthew Wong, Albuquerque, NM (US); Jeffrey Simon, Sudbury, MA (US)

(73) Assignee: HONEYWELL INTERNATIONAL INC., Morristown, NJ (US)

(21) Appl. No.: 13/665,806

(22) Filed: Oct. 31, 2012

(51) Int. Cl. G09B 9/08

(52) U.S. Cl. CPC G09B 9/08
USPC 434/35

(57) ABSTRACT

Systems and methods are described for evaluating maneuvers of an aircraft. In one embodiment, a method comprises performing steps on one or more processors. The steps comprise: setting a mode of a handheld device to a training mode. When in the training mode, the steps comprise tracking realtime flight data; retrieving standards data based on a maneuver type associated with the realtime flight data; and evaluating the realtime flight data based on the standards data.

### TECHNICAL FIELD

The present disclosure generally relates to flight training and evaluation, and more particularly relates to methods and systems for flight training and evaluation that are integrated with a handheld and portable device.

### BACKGROUND

All Federal Aviation Administration certifications for piloting, whether it be for a private pilot or an airline transport, have a certain set of fixed maneuvers that the pilot must perform in order to demonstrate proficiency and competency for the pilot rating. All of these maneuvers have a set pass criteria. During training, the instructor or evaluator will use his or her own judgment to determine if the student's maneuvers are acceptable. While this is useful, it doesn't provide the student with feedback during solo training or practicing.

As a result, it is desirable to provide methods and systems for evaluating and providing feedback to both a student pilot and an instructor during maneuvering practice and/or during the instructor's evaluation. It is further desirable to provide the methods and systems that are portable and handheld. Other desirable features and characteristics will become apparent from the subsequent detailed description and the appended claims, taken in conjunction with the accompanying drawings and this background of the invention.

### BRIEF SUMMARY

According to various exemplary embodiments, systems and methods are described for evaluating maneuvers of an aircraft. In one embodiment, a method comprises performing steps on one or more processors. The steps comprise: setting a mode of a handheld device to a training mode. When in the training mode, the steps comprise tracking realtime flight data; retrieving standards data based on a maneuver type associated with the realtime flight data; and evaluating the realtime flight data based on the standards data.

Other embodiments, features and details are set forth in additional detail below.

### BRIEF DESCRIPTION OF THE DRAWINGS

The present invention will hereinafter be described in conjunction with the following figures, wherein like numerals denote like elements, and

FIG. 1 is a functional block diagram illustrating a portable handheld device that includes an evaluation system in accordance with exemplary embodiments;

FIG. 2 is a dataflow diagram of an evaluation system in accordance with exemplary embodiments; and

FIG. 3 is a flowchart illustrating an evaluation method in accordance with exemplary embodiments.

### DETAILED DESCRIPTION

The following detailed description of the invention is merely example in nature and is not intended to limit the invention or the application and uses of the invention. Furthermore, there is no intention to be bound by any theory presented in the preceding background or the following detailed description. As used herein, the term “module” refers to any hardware, software, firmware, electronic control component, processing logic, and/or processor device, individually or in any combination, including, without limitation: an application specific integrated circuit (ASIC), an electronic circuit, a processor (shared, dedicated, or group) and memory that executes one or more software or firmware programs, a combinational logic circuit, and/or other suitable components that provide the described functionality.

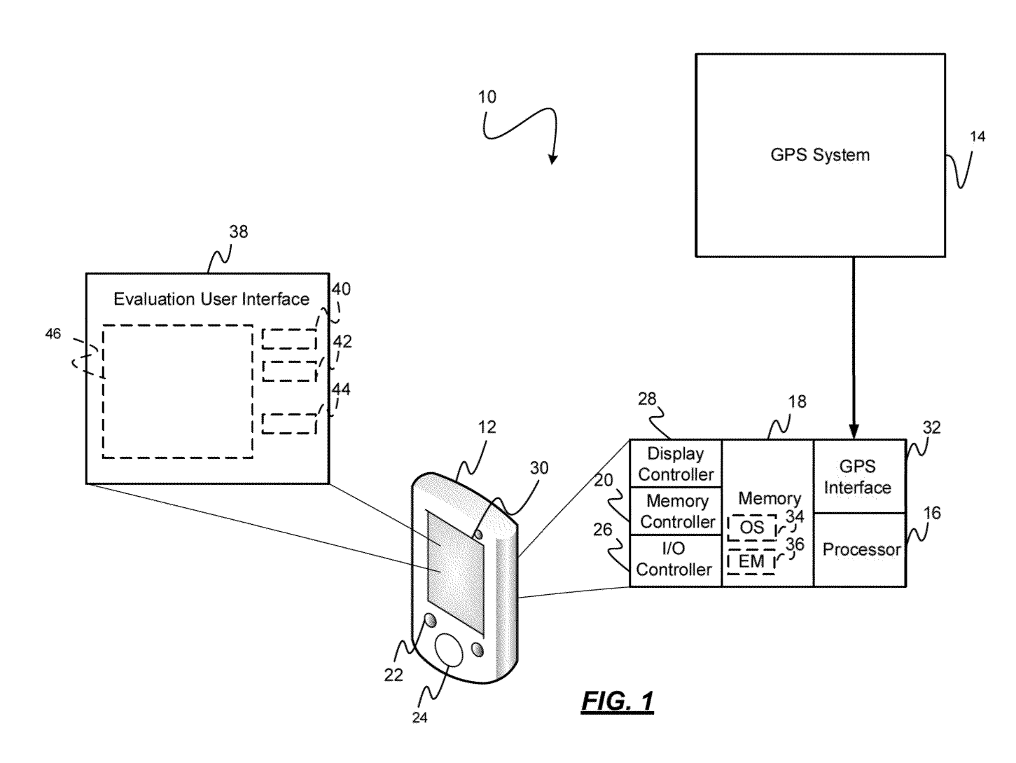

Turning now to the figures and with initial reference to FIG. 1, an exemplary computing system 10 is shown to include an evaluation system in accordance with various embodiments. Although the figures shown herein depict an example with certain arrangements of elements, additional intervening elements, devices, features, or components may be present in actual embodiments. It should also be understood that FIG. 1 is merely illustrative and may not be drawn to scale.

The computing system 10 is shown to include a handheld device 12 that communicates with an external system 14 according to one or more communication protocols to obtain data about an aircraft. In various embodiments, the external system 14 is a global positioning system (GPS) that provides positioning data to the handheld device 12. Data can also be derived from an attitude heading reference device, onboard aircraft data, or attitude gyros. As can be appreciated, the computing system 10 can include any handheld and portable computing device that capable of obtaining positioning data, such as, but not limited to, a laptop, an IPad, a IPod, a cell phone, a navigation device, or any other portable and handheld electronic device. For exemplary purposes, the disclosure will be discussed in the context of the handheld device 12 being a navigation device such as a GPS unit.

The exemplary handheld device 12 is shown to include at least one processor 16, memory 18 coupled to a memory controller 20, one or more input and/or output (I/O) devices 22, 24 (or peripherals) that are communicatively coupled via a local input/output controller 26, and a display controller 28 coupled to a display 30. In an exemplary embodiment, the I/O devices 22, 24 can include a touchpad, a keypad, touch sensors associated with the display 30 (e.g., a touchscreen), or any other input device. In an exemplary embodiment, the handheld device 12 can further include a GPS interface 32 for transmitting and/or receiving data between the handheld device 12 and the external system 14.

In various embodiments, the memory 18 stores instructions that can be performed by the processor 16. The instructions stored in memory 18 may include one or more separate programs, each of which comprises an ordered listing of executable instructions for implementing logical functions. In the example of FIG. 1, the instructions stored in the memory 18 include a suitable operating system (OS) 34. The operating system 34 essentially controls the performance of other computer programs and provides scheduling, input-output control, file and data management, memory management, and communication control and related services.

When the handheld device 12 is in operation, the processor 16 is configured to execute the instructions stored within the memory 18, to communicate data to and from the memory 18, and to generally control operations of the handheld device 12 pursuant to the instructions. The processor 16 can be any custom made or commercially available processor, a central processing unit (CPU), an auxiliary processor among several processors associated with the handheld device 12, a semiconductor based microprocessor (in the form of a microchip or chip set), a macroprocessor, or generally any device for executing instructions.

In various embodiments, the processor 16 executes instructions of the evaluation system of the present disclosure. The evaluation system generally includes an evaluation module (EM) 36 and an evaluation user interface 38. Generally speaking, the evaluation module 36 evaluates aircraft maneuvers based on information received from the external system 14. The evaluation may be performed on aircraft maneuvers performed by a pilot during training or practice. For example, the evaluation module 36 evaluates realtime data that is collected during the performance of the maneuver. The evaluation module 36 evaluates the realtime data based on predefined standards. The predefined standards provide a pass/fail status and/or a rating of the maneuver. The rating can include for example, but is not limited to, a “star” rating or using other evaluation criteria, such as, but not limited to, a scale of 1 to 10. The evaluation module presents results of the evaluation to a student pilot and/or an instructor during or after the training or practice.

The evaluation module 36 manages the interactions with the student pilot or the instructor through the evaluation user interface 38. For example, an instructor may interact with the evaluation user interface 38 using one or more of the input devices 22, 24 of the handheld device 12. In various embodiments, the evaluation user interface 38 includes one or more selection items 40, that when selected by the user, allows an evaluation mode of the handheld device 12 to be entered (as will be discussed in more detail below) and/or allows the evaluation mode to be exited thereby returning the handheld device 12 to a conventional mode.

In various embodiments, the evaluation user interface 38 includes one or more selection items 42, 44 that, when selected by a user, initiate and/or complete the evaluation process performed by the evaluation module 36. In various embodiments, the evaluation user interface 38 includes one or more display screens 46 that present the evaluated data and/or results of the evaluation to the student pilot and/or the instructor. The evaluation user interface 38 can present the evaluated data in realtime and/or after the maneuver has been performed.

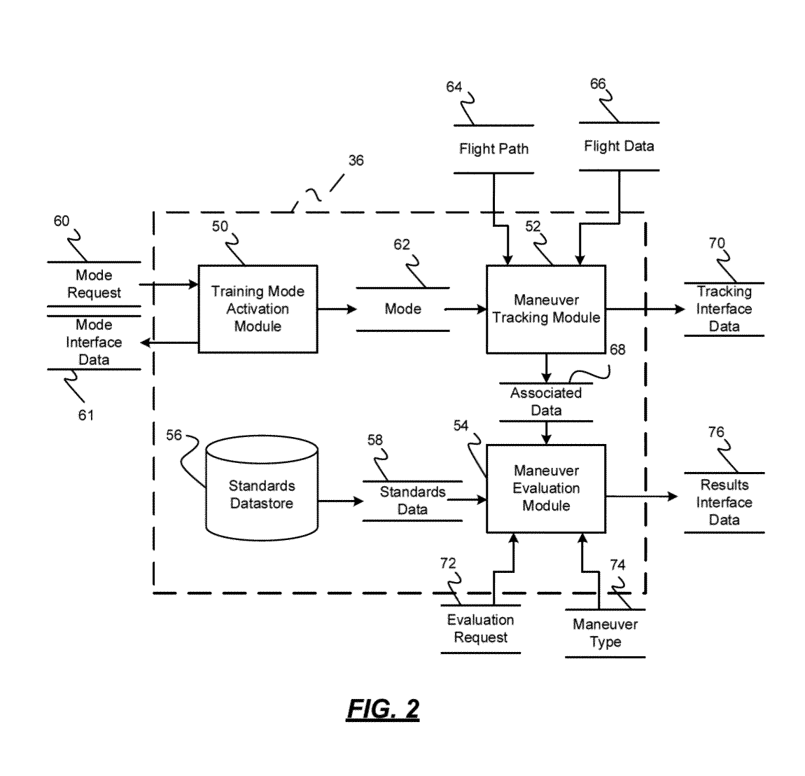

Referring now to FIG. 2, a dataflow diagram illustrates various embodiments of the evaluation module 36. Various embodiments of evaluation modules 36 according to the present disclosure may include any number of sub-modules embedded within the evaluation module 36. As can be appreciated, the sub-modules shown in FIG. 2 may be combined and/or further partitioned to similarly evaluate maneuvers of an aircraft. Inputs to the evaluation module 36 may be received from the external system 14, may be sensed by one or more sensory devices of the handheld device 12, may be received from other modules (not shown) within the handheld device 12 (FIG. 1), and/or determined/modeled by other sub-modules (not shown) within the evaluation module 36. In various embodiments, the evaluation module 36 includes a training mode activation module 50, a maneuver tracking module 52, a maneuver evaluation module 54, and a test standards datastore 56.

The test standards datastore 56 stores standards data 58. The standards data 58 indicates expected values or ranges of values for a particular maneuver that occurs for a particular segment of a flight path. In various embodiments, the standards data 58 can be predefined by, for example, a certification entity such as the FAA or any other entity or individual and can be based on test standards such as the FAA's Practical Test Standards (PTS) or any other standards. For example, the standards data can include, but are not limited to, how well a turn about a point maneuver is flown, or S-turns about a road is performed. How well altitude is held during a steep turn, or if any of the pass/fail criteria of a specific maneuver are violated.

The training activation mode module 50 receives as input a mode request 60. The mode request 60 may be received based on a user interacting with the selection item 40 of evaluation user interface 38. For example, the training activation mode module 50 manages a mode interface data 61 that generates the one or more selection items 40 that, when selected, initiates the mode request 60 to indicate a training mode request or a conventional mode request. When the mode request 60 indicates the training mode request, the training activation mode module 50 sets a mode 62 to a training mode. When the mode request 60 indicates the conventional mode request, the training activation mode module 50 sets the mode 62 to a conventional mode.

The maneuver tracking module 52 receives as input the mode 62, a flight path 64 of the aircraft, and realtime flight data 66 indicating conditions of the aircraft. The realtime flight data 66 can be sensed by the handheld device 12 or received from the external system 14. For example, the realtime flight data 66 can indicate geographical coordinates of the aircraft, can indicate an elevation of the aircraft, can indicate a speed of the aircraft, can indicate an acceleration of the aircraft, and/or can indicate other aircraft criteria such as altitude, speed, heading, turn rate, climb/decent rate, and/or position.

When the mode 62 indicates the training mode, the maneuver tracking module 52 tracks the realtime flight data 66 by associating the realtime flight data 66 with the flight path 64 and generating associated data 68. For example, the flight path 64 can include one or more segments and, as the realtime flight data 66 is collected, it is mapped to or associated with the segments of the flight path 64. In various embodiments, the realtime flight data 66 can be mapped or associated based on an elapsed time or a location of the aircraft, or any other tracking method. The realtime flight data 66 is mapped or associated such that particular maneuvers of the flight path 64 can be identified and evaluated.

In various embodiments, the maneuver tracking module 52 generates tracking interface data 70 that generates the display 46 of the associated data 68. The associated data 68 is displayed in a manner such that a visual evaluation may be performed by the student pilot and/or the instructor. For example, a visual depiction of the maneuver with an “expected path” and an actual path is displayed. For example in a landing pattern there is a set altitude and distance from the airport the aircraft should fly, these “targets” can be visually depicted and then the actual flight path can be overlaid. Following the completion of the maneuver the device can compare how close the actual flight was to the “ideal” flight path. In various embodiment, the maneuver tracking module 52 generates the tracking user interface data 70 based on a request initiated by the student pilot and/or the instructor when interacting with the evaluation user interface 38 (FIG. 1), and/or may be generated automatically at the completion of a maneuver or a flight path.

The maneuver evaluation module 54 receives as input the associated data 68. Either upon receipt of an evaluation request 72 or automatically at the completion of a maneuver, the maneuver evaluation module 54 evaluates the associated data 68. The maneuver evaluation module 54 evaluates the associated data 68 based on the standards data 58 retrieved from the standards datastore 56. For example, the maneuver evaluation module 54 retrieves the standards data 58 based on a maneuver type 74. The maneuver type 74 indicates a maneuver that has been performed. For example, the maneuver can include, but is not limited to, taxiing, a maximum performance climb, a traffic pattern work, steep turns, turns about a point, s-turns across a road, instrument approach procedures etc.

In various embodiments, the maneuver evaluation module 54 receives the maneuver type 74 as input based on a user interacting with the evaluation user interface 38 (FIG. 1). In various other embodiments, the maneuver evaluation module 54 evaluates the associated data 68 to determine the maneuver type 74. For example, the maneuver type 74 may be identified from the associated data 68 either based on an expected maneuver to be performed at a particular segment of the flight path or based on an evaluation of the realtime flight data 66.

The maneuver evaluation module 54 evaluates the associated data 68 by comparing the associated data 68 with the standards data 58. The maneuver evaluation module 54 generates a maneuver rating based on the comparing and presents the maneuver rating via results interface data 76. For example, if the associated data 68 falls within a first range of the standards data 58, a first maneuver rating can be generated. In another example, if the associated data 68 falls within a second range of the standards data, a second maneuver rating can be generated. As can be appreciated, any number of ranges can be used to generate any number of ratings in various embodiments.

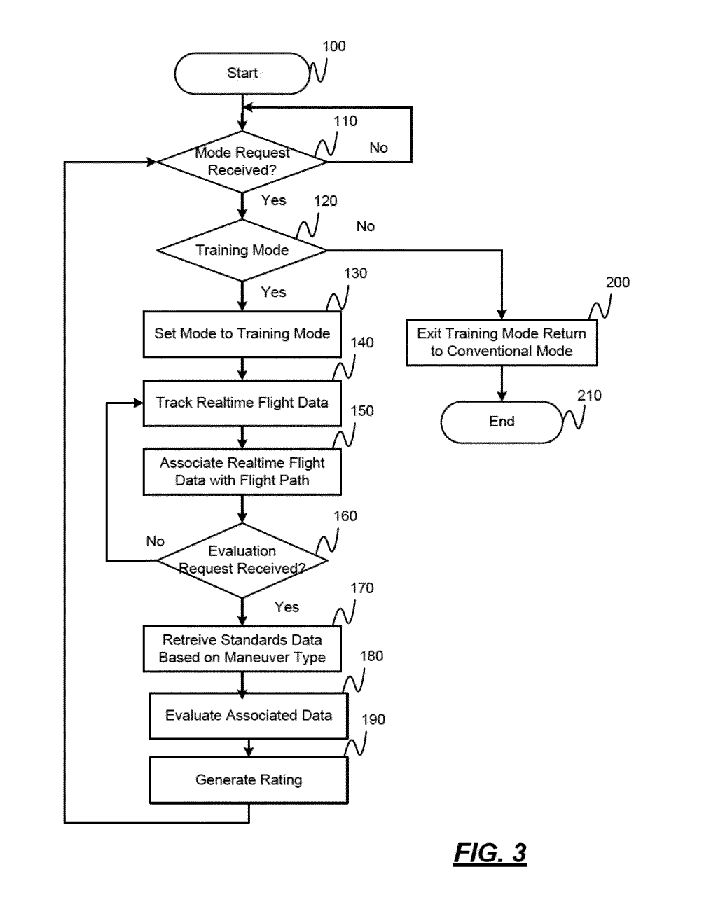

Referring now to FIG. 3, and with continued reference to FIGS. 1-2, a flowchart illustrates an evaluation method that can be performed by the evaluation module of FIG. 1 in accordance with the present disclosure. As can be appreciated in light of the disclosure, the order of operation within the methods is not limited to the sequential execution as illustrated in FIG. 3, but may be performed in one or more varying orders as applicable and in accordance with the present disclosure.

In various embodiments, the evaluation method may be scheduled to run based on predetermined events. In various other embodiments, evaluation methods can run continually at predetermined intervals during operation of the handheld device 12.

The method may begin at 100. It is determined whether a mode request 60 is received at 110. If the mode request 60 is not received at 110, the method continues with monitoring for the mode request 60 at 110. If the mode request 60 is received at 110, and indicates the training mode at 120, the mode 62 is set to the training mode at 130. The realtime flight data 66 is tracked at 140 and associated with the flight path 64 at 150.

It is determined whether an evaluation request 72 is received at 160. If an evaluation request 72 is received at 160, the method continues with tracking the realtime flight data at 140. If, however, an evaluation request 72 is received at 160, the standards data 58 is retrieved from the standards datastore 56 based on the maneuver type 74 that is either received or determined at 170. The associated data 68 is then evaluated based on the standards data 58 at 180 and the rating is generated at 190. Thereafter, the method continues with determining whether a mode request is received at 110. If, at 120, the mode request does not indicate the training mode rather it indicates the conventional mode, the mode 62 is set to the conventional mode and the training mode is exited at 200. Thereafter, the method may end at 210.

As can be appreciated, one or more aspects of the present disclosure can be included in an article of manufacture (e.g., one or more computer program products) having, for instance, computer usable media. The media has embodied therein, for instance, computer readable program code means for providing and facilitating the capabilities of the present disclosure. The article of manufacture can be included as a part of a computer system or provided separately.

Additionally, at least one program storage device readable by a machine, tangibly embodying at least one program of instructions executable by the machine to perform the capabilities of the present disclosure can be provided.

While at least one example embodiment has been presented in the foregoing detailed description of the invention, it should be appreciated that a vast number of equivalent variations exist. It should also be appreciated that the embodiments described above are only examples, and are not intended to limit the scope, applicability, or configuration of the invention in any way. Rather, the foregoing detailed description will provide those skilled in the art with a convenient road map for implementing various examples of the invention. It should be understood that various changes may be made in the function and arrangement of elements described in an example embodiment without departing from the scope of the invention as set forth in the appended claims and their legal equivalents.

What is claimed is:

1. A method for evaluating maneuvers of an aircraft, comprising:
performing steps on one or more processors, the steps comprising:
setting a mode of a handheld device to a training mode; and
when in the training mode,
tracking realtime flight data;
retrieving standards data based on a maneuver type associated with the realtime flight data; and
evaluating the realtime flight data based on the standards data.

2. The method of claim 1, wherein the steps further comprise associating the realtime flight data with a flight path.

3. The method of claim 2, wherein the steps further comprise identifying the maneuver type based on the associating.

4. The method of claim 1, wherein the steps further comprise generating a rating based on the evaluating the realtime flight data.

5. The method of claim 1, wherein the evaluating the realtime flight data comprises comparing the realtime flight data with the standards data.

6. The method of claim 1, wherein the steps further comprise setting the mode to a conventional mode and exiting the training mode.

7. A handheld device, comprising:
a computer readable medium comprising:
a first module that sets a mode of the handheld device to a training mode;
a second module that tracks realtime flight data when in the training mode;
a third module that retrieves standards data based on a maneuver type associated with the realtime flight data, and that evaluates the realtime flight data based on the standards data.

8. The handheld device of claim 7, wherein the second module associates the realtime flight data with a flight path.

9. The handheld device of claim 8, wherein the third module identifies the maneuver type based on the associating.

10. The handheld device of claim 7, wherein the third module generates a rating based on the evaluating the realtime flight data.

11. The handheld device of claim 7, wherein the third module evaluates the realtime flight data by comparing the realtime flight data with the standards data.

12. The handheld device of claim 7, wherein the first module sets the mode to a conventional mode and exits the training mode.

13. A computer program product for evaluating aircraft maneuvers, comprising:
a tangible storage medium readable by a processing circuit and storing instructions for execution by the processing circuit for performing a method, the method comprising:
setting a mode of a handheld device to a training mode; and
when in the training mode,
tracking realtime flight data;
retrieving standards data based on a maneuver type associated with the realtime flight data; and
evaluating the realtime flight data based on the standards data.

14. The computer program product of claim 13, wherein the method further comprises The method of claim 1, wherein the steps further comprise associating the realtime flight data with a flight path.

15. The computer program product of claim 14, wherein the method further comprises identifying the maneuver type based on the associating.

16. The computer program product of claim 13, wherein the method further comprises generating a rating based on the evaluating the realtime flight data.

17. The computer program product of claim 13, wherein the evaluating the realtime flight data comprises comparing the realtime flight data with the standards data.

18. The computer program product of claim 13, wherein the method further comprises setting the mode to a conventional mode and exiting the training mode.
